(19) United States
(12) Patent Application Publication
(10) Pub. No.: US 2017/0136822 A1
(43) Pub. Date: May 18, 2017

(54) PNEUMATIC TIRE

(71) Applicant: TOYO TIRE & RUBBER CO., LTD., Osaka (JP)

(72) Inventor: Kouichi Takita, Osaka (JP)

(73) Assignee: TOYO TIRE & RUBBER CO., LTD., Osaka (JP)

(21) Appl. No.: 15/337,255

(22) Filed: Oct. 28, 2016

(30) Foreign Application Priority Data
Nov. 16, 2015 (JP) 2015-224087

(51) Int. Cl. B60C 9/30; B60C 11/03

(52) U.S. Cl. CPC B60C 9/30; B60C 11/0304; B60C 11/0306; B60C 2011/0386

(57) ABSTRACT

A pneumatic tire includes a cap ply disposed between a belt layer and a tread portion so as to wholly cover the belt layer in a tire width direction, and two edge plies disposed between the belt layer and the tread portion so as to respectively cover edge portions of the belt layer in a tire width direction. A first region and a second region are formed by dividing the tread portion in two by a tire equator plane. The first region has a first void ratio, and the second region has a second void ratio smaller than the first void ratio.

### CROSS-REFERENCE TO RELATED APPLICATIONS

This application claims priority of Japanese Patent Application No. 2015-224087 filed on Nov. 16, 2015, the content of which is incorporated herein by reference.

### BACKGROUND OF THE INVENTION

Technical Field

The present invention relates to a pneumatic tire.

Related Art

JP 8-238908 A discloses a pneumatic radial tire where a large ply-steer residual cornering force (PRCF) is generated on the pneumatic radial tire by making sizes of a pair of edge covers in a tire width direction different from each other. This pneumatic radial tire is intended to be used as a test-use tire.

### SUMMARY

When a pneumatic tire which adopts an asymmetrical tread pattern (asymmetrical pattern) is mounted on a vehicle, side sliding of the vehicle is liable to be generated due to conicity caused by the asymmetrical pattern. JP 8-238908 A does not specifically teach the suppression of side sliding of a vehicle on which a pneumatic tire having an asymmetrical pattern is mounted.

It is an object of the present invention to suppress side sliding of a vehicle with respect to a pneumatic tire with an asymmetrical pattern.

A first aspect of the present invention provides a pneumatic tire including: a tread portion having an asymmetrical pattern; a belt layer disposed between a carcass and the tread portion, and having two or more belts; a cap ply disposed between the belt layer and the tread portion so as to wholly cover the belt layer in a tire width direction; and two edge plies disposed between the belt layer and the tread portion so as to respectively cover edge portions of the belt layer in a tire width direction, where a first region with a first void ratio and a second region with a second void ratio are formed by dividing the tread portion in two by a tire equator plane, wherein the edge ply is disposed outside the cap ply in a tire radial direction in the first region, and wherein the edge ply is disposed inside the cap ply in the tire radial direction in the second region.

The void ratio (first void ratio) in the first region of the tread portion is larger than the void ratio (second void ratio) in the second region. This difference in void ratio generates conicity directed toward the first region from the second region. A constraining force in the tire radial direction which acts on the belt layer from the cap ply is relatively uniform over the entire tire width direction. On the other hand, a constraining force in the tire radial direction which acts on the belt layer from the edge ply acts in a concentrated manner on the edge portion of the belt layer and a periphery of the edge portion. Accordingly, a constraining force in the vicinity of the edge portion of the belt layer in the first region where the edge ply is disposed outside the cap ply in the tire radial direction is larger than a constraining force in the vicinity of the edge portion of the belt layer in the second region where the edge ply is disposed inside the cap ply in the tire radial direction. This difference in constraining force generates conicity directed toward the second region from the first region. The direction of conicity caused by the difference in arrangement of the edge ply with respect to the cap ply between the first region and the second region is opposite to the direction of conicity caused by the difference in void ratio between the first region and the second region. Accordingly, the former conicity caused by the difference in arrangement of the edge ply with respect to the cap ply acts so as to cancel the latter conicity caused by the difference in void ratio. As a result, conicity caused by the difference in void ratio is reduced so that side sliding of the vehicle can be suppressed.

The difference in constraining force caused by the difference in arrangement of the edge ply with respect to the cap ply between the first region and the second region acts so as to cancel non-uniformity of a ground contact pressure between the first region and the second region caused by the difference in void ratio. As a result, the difference in wear property between the first region and the second region caused by the difference in void ratio is reduced so that uneven wear resistance is enhanced.

For example, a tread pattern in a first mediate portion included in the first region is a block pattern, and a tread pattern in a second mediate portion included in the second region is a rib pattern.

For example, the belt positioned on an outermost side in the tire radial direction among the belts which form the belt layer has a rate of a width to a total tire width set to 0.80 or more.

When the ratio of the width of the belt to the total tire width in the tire width direction falls within this range, conicity caused by the difference in void ratio between the first region and the second region is canceled by conicity caused by the difference in arrangement of the edge ply with respect to the cap ply between the first region and the second region and hence, side sliding of a vehicle can be effectively suppressed. The pneumatic tire where the ratio of the width of the belt to the total tire width in the tire width direction falls within this range includes a vehicle-use tire having a relatively low flatness ratio and a small-sized truck-use tire of a so-called square-type.

For generating proper conicity based on the difference in arrangement of the edge ply with respect to the cap ply, for example, an inclination angle of a straight line which connects an edge portion of the edge ply inside in the tire width direction in the first region and an edge portion of the edge ply inside in the tire width direction in the second region with respect to the tire width direction is set to a value which falls within a range from 1° to 10° inclusive.

With respect to a crown rounded shape which allows setting of such an inclination angle, for example, a thickness of the belt layer on the tire equator plane is set to a value which falls within a range from 14 mm to 16 mm inclusive, and a thickness of the belt layer at an edge portion in the tire width direction is set to 0.4 times or more and 0.8 times or less as large as the thickness of the belt layer on the tire equator plane.

To generate proper conicity based on the difference in arrangement of the edge ply with respect to the cap ply, for example, a width of the edge ply in the second region is set to 0.9 times or more and 1.1 times or less as large as a width of the edge ply in the first region. Further, a projection amount of the edge ply from a ground contact edge is 5% or more and 20% or less of a total tire width.

A second aspect of the present invention provides a pneumatic tire including: a tread portion having an asymmetrical pattern; a belt layer disposed between a carcass and the tread portion, and having two or more belts; a cap ply disposed between the belt layer and the tread portion so as to wholly cover the belt layer in a tire width direction; and two edge plies disposed between the belt layer and the tread portion so as to respectively cover edge portions of the belt layer in a tire width direction wherein a first region and a second region are formed by dividing the tread portion in two by a tire equator plane, a tread pattern in a first mediate portion included in the first region is a block pattern, and a tread pattern in a second mediate portion included in the second region is a rib pattern, wherein the edge ply is disposed outside the cap ply in a tire radial direction in the first region, and wherein the edge ply is disposed inside the cap ply in the tire radial direction in the second region.

The mediate portion included in the first region of the tread portion (first mediate portion) is formed of the block pattern, and the mediate portion included in the second region (second mediate portion) is formed in the rib pattern. Accordingly, conicity directed toward the first region from the second region is generated. The direction of conicity caused by the difference in arrangement of the edge ply with respect to the cap ply between the first region and the second region is opposite to the direction of conicity caused by the difference in tread pattern of the mediate portion between the first region and the second region. Accordingly, the former conicity caused by the difference in arrangement of the edge ply with respect to the cap ply acts so as to cancel the latter conicity caused by the difference in the tread pattern of the mediate portion. As a result, conicity caused by the difference in the tread pattern of the mediate portion is reduced and hence, side sliding of a vehicle is suppressed.

According to the pneumatic tire of the present invention, side sliding of a vehicle on which a pneumatic tire having an asymmetrical pattern is mounted can be suppressed.

### BRIEF DESCRIPTION OF THE DRAWINGS

The foregoing and the other features of the present invention will become apparent from the following description and drawings of an illustrative embodiment of the invention in which:

FIG. 1 is a meridian cross-sectional view of a pneumatic tire according to a first embodiment of the present invention;

FIG. 2 is an enlarged view of a part II in FIG. 1;

FIG. 3 is an enlarged view of a part III in FIG. 2;

FIG. 4 is a schematic cross-sectional view of a cap ply and edge plies;

FIG. 5 is a meridian cross-sectional view of a pneumatic tire according to a third embodiment of the present invention;

FIG. 6 is an enlarged view of a part VI in FIG. 5; and

FIG. 7 is an enlarged view of a part VII in FIG. 5.

### DETAILED DESCRIPTION OF EMBODIMENTS

Next, embodiments of the present invention are described with reference to attached drawings.

### First Embodiment

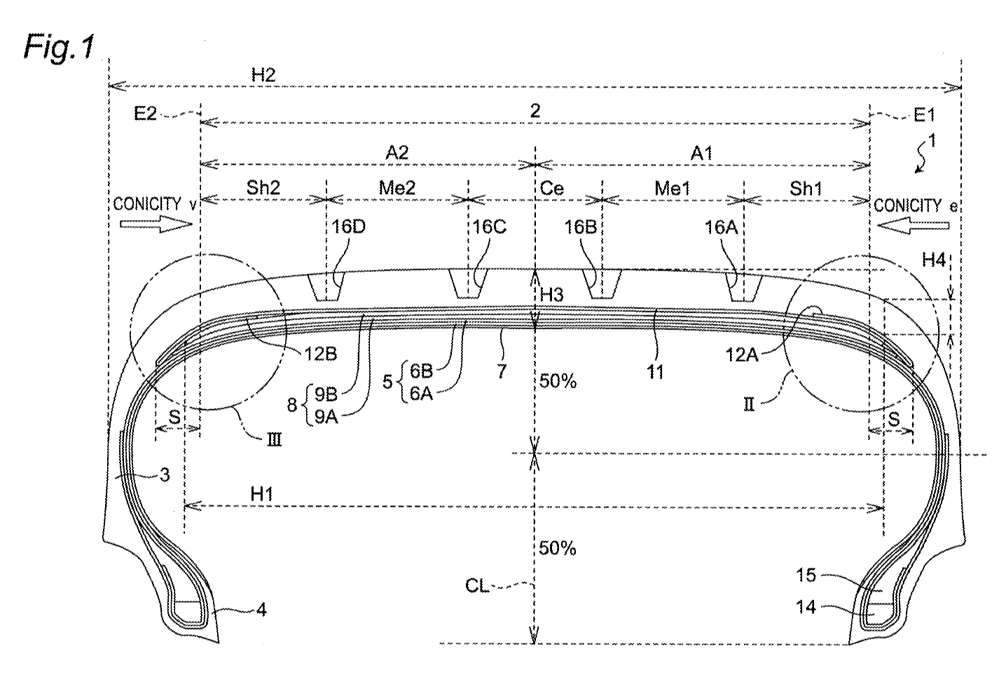

FIGS. 1 to 3 show a pneumatic tire made of rubber (hereinafter, referred to as a tire) 1 according to a first embodiment of the present invention.

The tire 1 includes a tread portion 2, a pair of side portions 3, and a pair of bead portions 4. Each bead portion 4 is provided to an edge portion of the side portion 3 on an inner side in a tire radial direction (an edge portion on a side opposite to the tread portion 2). A carcass 5 is disposed between the pair of bead portions 4. In this embodiment, the carcass 5 has two carcass plies 6A, 6B. An inner liner 7 is disposed on an innermost peripheral surface of the tire 1.

A belt layer 8 is disposed between the carcass 5 and a tread surface of the tread portion 2. In this embodiment, the belt layer 8 has two belts 9A, 9B. The belt layer 8 may have three or more belts. To compare the belt 9A (the belt in an innermost layer) on an inner side in the tire radial direction and the belt 9B (the belt in an outermost layer) on an outer side in the tire radial direction to each other, the belt 9A has a larger size (width) in a tire width direction than the belt 9B has.

A cap ply 11 and two edge plies 12A, 12B are disposed between the belt layer 8 and the tread surface of the tread portion 2. In this embodiment, the cap ply 11 and two edge plies 12A, 12B are formed as one continuous member. Specifically, the cap ply 11 and the edge plies 12A, 12B are obtained by continuously winding a tape in a spiral shape in the tire circumferential direction. The tape is formed by covering a plurality of cords arranged parallel to each other in a longitudinal direction thereof by topping rubber.

The bead portion 4 has a bead core 14 and a bead filler 15. At the periphery of the bead core 14, an edge portion of the carcass 5 in the tire width direction is wound around the bead filler 15 in a direction from the inside to the outside in the tire width direction.

The tread portion 2 has an asymmetric tread pattern (asymmetrical pattern). Formed on the tread portion 2 are four main grooves 16A to 16D extending in a tire circumferential direction as well as a large number of lateral grooves (not shown) extending in a tire width direction so as to intersect with the main grooves 16A to 16D.

In the description hereinafter, a portion of the tread portion 2 between two main grooves 16B, 16C which are disposed adjacently to a tire equator plane CL may be also referred to as a center portion Ce. Further, portions of the tread portion 2 which are disposed adjacently to and outside of the center portion Ce in the tire width direction may be also referred to as mediate portions Me1, Me2. The mediate portion Me1 is a portion disposed between the main grooves 16A, 16B, while the mediate portion Me2 is a portion disposed between the main grooves 16C, 16D. Portions of the tread portion 2 which are disposed adjacently to and outside mediate portions Me1, Me2 in the tire width direction may be also referred to as shoulder portions Sh1, Sh2. The shoulder portion Sh1 is a portion disposed between the main groove 16A and a ground contact edge E1, and the shoulder portion Sh2 is a portion disposed between the main groove 16D and a ground contact edge E2.

In this embodiment, the center portion Ce is formed in a rib pattern, and the mediate portions Me1, Me2 and the shoulder portions Sh1, Sh2 are respectively formed in a block pattern.

In the description hereinafter, regions formed by dividing the tread portion 2 in two in the tire width direction by the tire equator plane CL may be also referred to as a first region A1 and a second region A2, respectively. The first region A1 is a region ranging from the tire equator plane CL to the ground contact edge E1, and the second region A2 is a region ranging from the tire equator plane CL to the ground contact edge E2.

The first region A1 and the second region A2 differ from each other in a void ratio of a tread pattern. The void ratio indicates a ratio of a groove area to a ground contact area by percentage, and can be expressed by the following formula.

$$( Void ration ) = \{ 1 - \frac{( Actual ground contact area )}{( Ground contact area )} \} \times 100$$

In this formula, the ground contact area is a sum of areas of land portions and areas of groove portions, and the actual ground contact area is the areas of the land portions.

Specifically, a void ratio (first void ratio) V1 in the first region A1 is larger than a void ratio (second void ratio) V2 in the second region A2 (V1>V2). Conversely, the void ratio V2 in the second region A2 is smaller than the void ratio V1 in the first region A1. An amount of tread rubber in the first region A1 where the void ratio V1 is large is smaller than an amount of tread rubber in the second region A2 where the void ratio is small. Accordingly, rigidity of the tread portion 2 in the first region A1 is lower than rigidity of the tread portion 2 in the second region A2. The difference in rigidity between the first region A1 and the second region A2 generates a force in a lateral direction or in a tire axial direction is generated. That is, the difference in rigidity between the first region A1 and the second region A2 generates conicity directed toward the first region A1 where the void ratio V1 is large from the second region A2 where the void ratio V2. In the description made hereinafter, this conicity is expressed as conicity “v”. Conicity “v” deteriorates straight traveling stability of a vehicle thus causing side sliding of the vehicle.

With reference to FIG. 1, both edge portions of the cap ply 11 in the tire width direction are positioned outside both edge portions of the belt layer 8 in the tire width direction (particularly, both edge portions of the belt 9A having a large width disposed inside in the tire radial direction). That is, the cap ply 11 is disposed so as to wholly cover the belt layer 8 in the tire width direction.

Both edge portions of the cap ply 11 in the tire width direction are folded back, and the folded back portions form edge plies 12A, 12B. The edge ply 12A is disposed so as to cover one-side edge portions 17a, 18a of the belts 9A, 9B outside in the tire width direction and an area around one-side edge portions 17a, 18a. On the other hand, the edge ply 12B is disposed so as to cover the other-side edge portions 17b, 18b of the belts 9A, 9B in the tire width direction and an area around the other-side edge portions 17b, 18b.

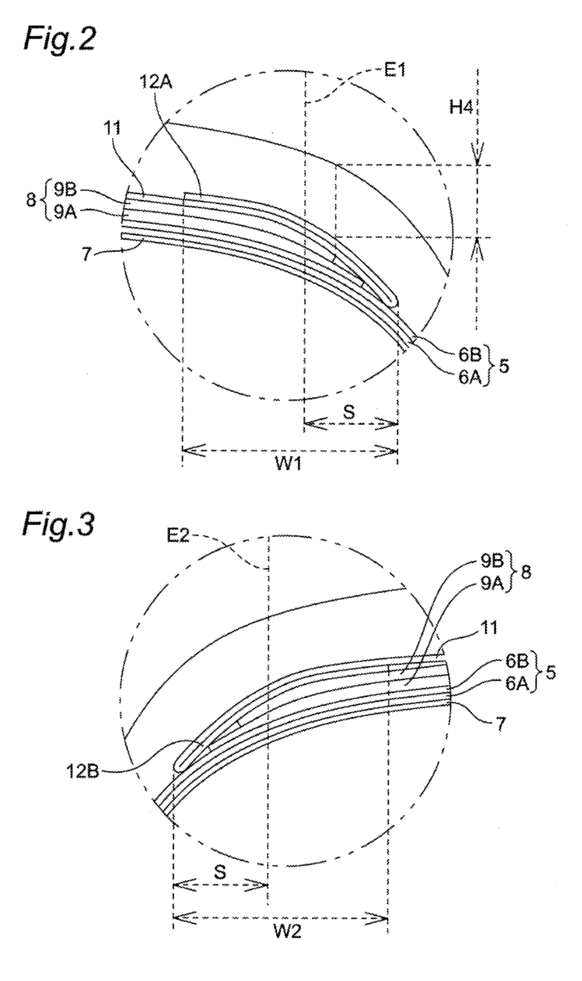

As most clearly shown in FIG. 2, in the first region A1 where the void ratio V1 is large, the edge ply 12A is disposed in an overlapping manner with an outer side of the cap ply 11 in the tire radial direction. On the other hand, as most clearly shown in FIG. 3, in the second region A2 where the void ratio V2 is small, the edge ply 12B is disposed adjacently to an inner side of the cap ply 11 in the tire radial direction.

A constraining force in the tire radial direction which acts on the belt layer 8 from the cap ply 11 is relatively uniform wholly over the tire width direction. On the other hand, a constraining force in the tire radial direction which acts on the belt layer 8 from the edge plies 12A, 12B acts in a concentrated manner on the edge portions of the belt layer 8 and areas around the edge portions of the belt layer 8. Accordingly, a constraining force in the vicinity of the edge portion of the belt layer 8 in the first region A1 where the edge ply 12A is disposed outside the cap ply 11 in the tire radial direction is larger than a constraining force in the vicinity of the edge portion of the belt layer 8 in the second region A2 where the edge ply 12B is disposed inside the cap ply 11 in the tire radial direction. This difference in constraining force generates conicity directed toward the second region A2 from the first region A1. In the description made hereinafter, such conicity is expressed as conicity “e”. The direction of conicity “e” is opposite to the direction of conicity “v” caused by the difference in void ratio between the first region A1 and the second region A2 described previously. Accordingly, conicity “e” caused by the difference in arrangement of the edge plies 12A, 12B with respect to the cap ply 11 acts so as to cancel conicity “v” caused by the difference in void ratio. As a result, conicity “v” caused by the difference in void ratio is reduced so that the side sliding of a vehicle can be suppressed.

The difference in constraining force between the first region A1 and the second region A2 caused by the difference in arrangement of the edge plies 12A, 12B with respect to the cap ply 11 acts so as to cancel non-uniformity of a ground contact pressure between the first region A1 and the second region A2 caused by the difference in void ratio. As a result, the difference in wear property between the first region A1 and the second region A2 caused by the difference in void ratio can be reduced so that uneven wear resistance is enhanced.

With reference to FIG. 1, in the tire 1 of this embodiment, a rate (H1/H2) of a width H1 of the belt 9A which is an outermost layer in the belt layer 8 to a total tire width H2 is set to 0.80 or more. In this embodiment, the total tire width H2 is a size of the tire 1 in a tire width direction at the position which is ½ of a distance from an innermost edge of the bead portion 4 in the tire radial direction to a tread surface of the tread portion 2 on the tire equator plane CL.

By setting the rate H1/H2 to 0.89 or more, conicity “v” caused by the difference in void ratio between the first region A1 and the second region A2 can be canceled by conicity “e” caused by the difference in arrangement of the edge plies 12A, 12B with respect to the cap ply 11 between the first region A1 and the second region A2 and hence, side sliding of the vehicle can be effectively suppressed. The pneumatic tire where the ratio H1/H2 falls within this range includes a vehicle-use tire having a relatively low flatness ratio and a small-sized truck-use tire of a so-called square-type.

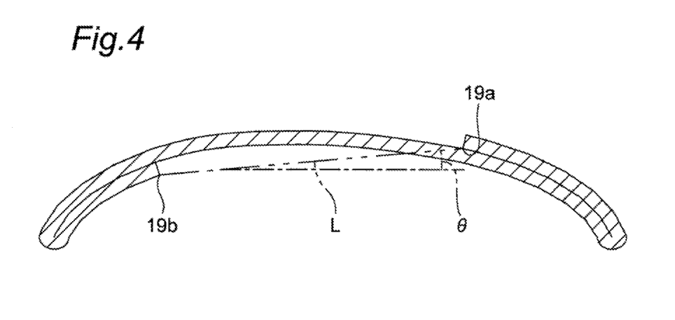

With reference to FIG. 4, a straight line L which connects an edge portion 19a of the edge ply 12A inside in the tire width direction in the first region A1 and an edge portion 19b of the edge ply 12B inside in the tire width direction in the second region A2 to each other has an inclination angle θ with respect to the tire width direction. To generate proper conicity “e” by the difference in arrangement of the edge plies 12A, 12B with respect to the cap ply 11, the inclination angle θ is set to a value which falls within a range from 1° to 10° inclusive, for example.

To set the inclination angle θ to a value which falls within a range from 1° to 10°, among parameters relating to a crown rounded shape of the tread portion 2, a thickness H3 of the tread portion on the tire equator plane CL and a thickness H4 of the tread portion 2 at edge portions of the belt layer 8 in the tire width direction (edge portions 18a, 18b of the belt 9B which forms the outermost layer in the tire width direction) can be set as follows, for example. That is, the thickness H3 of the tread portion on the tire equator plane CL can be set to a value which falls within a range from 14 mm to 16 mm inclusive, and the thickness H4 of the tread portion 2 at the edge portions of the belt layer 8 in the tire width direction can be set to 0.4 times or more and 0.8 times or less as large as the thickness H3 of the tread portion on the tire equator plane CL.

To generate proper conicity “e” by the difference in arrangement of the edge plies 12A, 12B with respect to the cap ply 11, a width W2 of the edge ply 12B in the second region A2 is set to 0.9 times or more and 1.1 times or less as large as a width W1 of the edge ply 12A in the first region A1, for example.

Further, in order to generate proper conicity “e” by the difference in arrangement of the edge plies 12A, 12B with respect to the cap ply 11, projection amounts S1, S2 of the edge plies 12A, 12B from the ground contact edges are set to values which fall within a range from 5% to 20% (inclusive) of the total tire width H2, for example.

Hereinafter, second to fourth embodiments of the present invention are described. In the description of these embodiments, the description is made with respect to configurations differ from those of the first embodiment, and the configurations common to those of the first embodiment are not described unless otherwise necessary. Further, in the drawings relating to these embodiments, elements identical or similar to those in the first embodiment are given the same symbols.

### Second Embodiment

With reference to FIGS. 1 to 4, in this embodiment, the center portion Ce is formed in a rib pattern, and both shoulder portions Sh1, Sh2 are formed in a block pattern. The mediate portion Me1 included in the first region A1 where a void ratio V1 is large is formed in a block pattern, and the mediate portion Me2 included in the second region A2 where a void ratio is small is formed in a rib pattern.

Similarly to the first embodiment, in the first region A1 where the void ratio V1 is large, the edge ply 12A is disposed in an overlapping manner with the outer side of a cap ply 11 in a tire radial direction, while in the second region A2 where a void ratio V2 is small, the edge ply 12B is disposed adjacently to the inner side of the cap ply 11 in the tire radial direction. Conicity “e” caused by the difference in arrangement of the edge plies 12A, 12B with respect to the cap ply 11 acts so as to cancel conicity “v” caused by the difference in void ratio so that side sliding of a vehicle can be suppressed. The difference in constraining force caused by the difference in arrangement of the edge plies 12A, 12B with respect to the cap ply 11 acts so as to cancel non-uniformity of a ground contact pressure caused by the difference in void ratio and hence, wear resistance is enhanced.

Even supposed to that the void ratio V1 in the first region A1 and the void ratio V2 in the second region A2 are equal, since the mediate portion Me1 in the first region A1 is formed in a block pattern and the mediate portion Me2 in the second region A2 is formed in a rib pattern, difference in the rigidity is generated between these regions. Specifically, even when the void ratios V1, V2 in two regions are equal, rigidity of the tread portion 2 in the first region A1 where the mediate portion Me1 is formed in a block pattern is lower than rigidity of the tread portion 2 in the second region A2 where the mediate portion Me2 is formed in a rib pattern. As a result, conicity directed toward the first region A1 from the second region A2 is generated. Conicity “e” caused by the difference in arrangement of the edge plies 12A, 12B with respect to the cap ply 11 acts so as to cancel conicity caused by the difference in rigidity (directed in the same direction as conicity “v” in the first embodiment). As a result, side sliding of the vehicle is suppressed.

### Third Embodiment

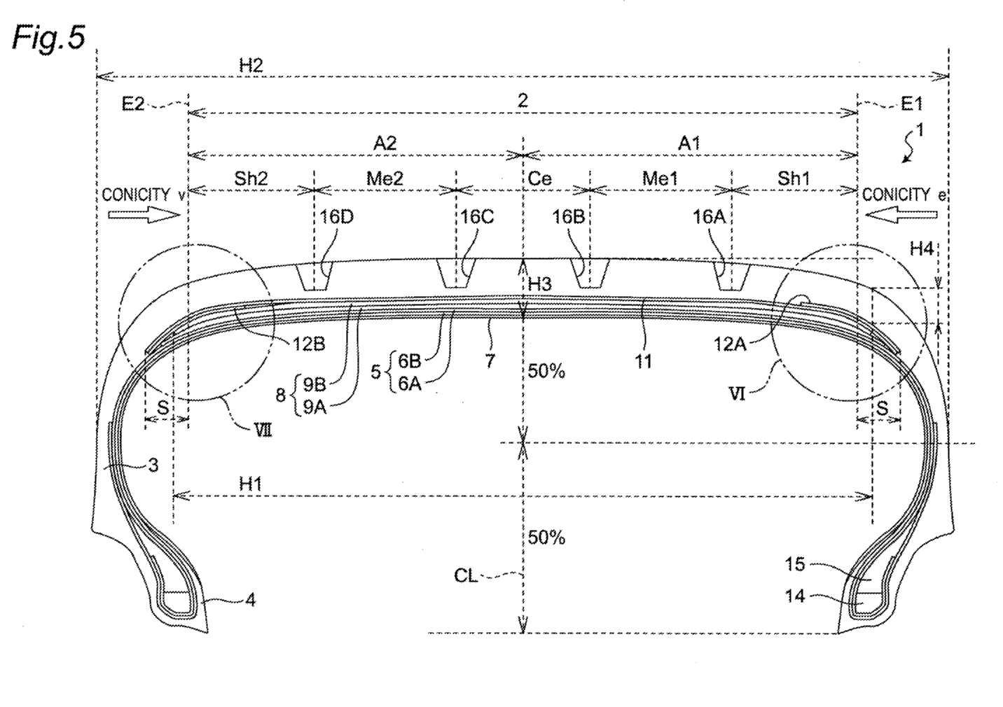

FIGS. 5 to 7 show a tire 1 according to a third embodiment of the present invention.

In this embodiment, similarly to the first embodiment, a center portion Ce is formed in a rib pattern, and both mediate portions Me1, Me2 and shoulder portions Sh1, Sh2 are formed in a block pattern. A void ratio V1 in a first region A1 is larger than a void ratio V2 in a second region A2.

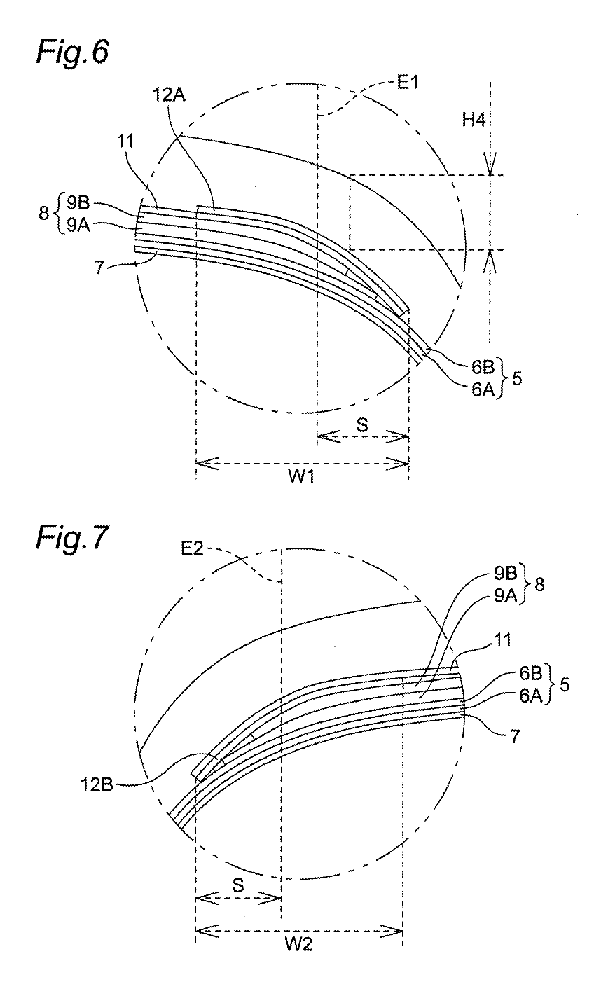

As most clearly shown in FIG. 6, an edge ply 12A in the first region A1 is not continuously formed with a cap ply 11, but is formed as a separate body from the cap ply 11. Similarly, as most clearly shown in FIG. 7, an edge ply 12B in the second region A2 is not continuously formed with the cap ply 11, but is formed as a separate body from the cap ply 11. The edge ply 12A is disposed in an overlapping manner with an outer side of the cap ply 11 in a tire radial direction, and the edge ply 12B is disposed adjacently to an inner side of the cap ply 11 in the tire radial direction.

Conicity “e” caused by the difference in arrangement of the edge plies 12A, 12B with respect to the cap ply 11 acts so as to cancel conicity “v” caused by the difference in void ratio so that side sliding of the vehicle can be suppressed. The difference in constraining force caused by the difference in arrangement of the edge plies 12A, 12B with respect to the cap ply 11 acts so as to cancel non-uniformity of a ground contact pressure caused by the difference in void ratio so that wear resistance is enhanced.

Either one of the edge plies 12A, 12B may be continuously formed with the cap ply 11, and the other of the edge plies 12A, 12B may be formed as a separate body from the cap ply 11.

### Fourth Embodiment

With reference to FIGS. 5 to 7, in this embodiment, a center portion Ce is formed in a rib pattern, and both shoulder portions Sh1, Sh2 are formed in a block pattern. A mediate portion Me1 included in a first region A1 with a large void ratio V1 is formed in a block pattern, and a mediate portion Me2 included in a second region A2 with a small void ratio formed in a rib pattern.

In the first region A1 where the void ratio V1 is large, an edge ply 12A is disposed in an overlapping manner with an outer side of a cap ply 11 in a tire radial direction, while in the second region A2 where the void ratio V2 is small, an edge ply 12B is disposed adjacently to an inner side of the cap ply 11 in the tire radial direction. Conicity “e” caused by the difference in arrangement of the edge plies 12A, 12B with respect to the cap ply 11 acts so as to cancel conicity “v” caused by the difference in void ratio so that side sliding of the vehicle can be suppressed. The difference in constraining force caused by the difference in arrangement of the edge plies 12A, 12B with respect to the cap ply 11 acts so as to cancel non-uniformity of a ground contact pressure caused by the difference in void ratio so that wear resistance is enhanced.

As described in conjunction with the second embodiment, even supposed to that the void ratio V1 in the first region A1 and the void ratio V2 in the second region A2 are equal, since the mediate portion Me1 in the first region A1 is formed in a block pattern and the mediate portion Me2 in the second region A2 is formed in a rib pattern, difference in rigidity is generated between both regions. Conicity “e” caused by the difference in arrangement of the edge plies 12A, 12B with respect to the cap ply 11 acts so as to cancel conicity caused by the difference in rigidity so that side sliding of the vehicle can be suppressed.

(Evaluation Test)

An evaluation test was carried out on tires of comparison examples 1, 2 and tires of examples 1, 2 shown in the following Table 1 with respect to side sliding and uneven wear resistance. Data not specifically referred to in Table 1 are substantially equal among the comparison examples 1, 2 and the examples 1, 2. Particularly, in all these examples, a tire size is 225/45R 18. Further, in all these examples, a tread portion has an asymmetrical pattern. In Table 1 and the description made hereinafter, the term “region” means an individual region formed by dividing the tread portion in two by a tire equator plane (first or second region in the first to fourth embodiments).

TABLE 1

| | Comparison | Comparison | | |
|---|---|---|---|---|
| | Example 1 | Example 2 | Example 1 | Example 2 |
| Tread pattern | Asymmetrical | Asymmetrical | Asymmetrical | Asymmetrical |
| | pattern | pattern | pattern | pattern |
| Region where edge | Region where | Region where | Region where void | Region where |
| ply is overlapped with | void ratio is | mediate portion | ratio is large (region | mediate portion is |
| outer side of cap ply | small (region | is formed in rib | where void ratio is | formed in block |
| (region where edge | where void | pattern (region | small) | pattern (region |
| ply is positioned | ratio is large) | where mediate | | where mediate |
| inside cap ply) | | portion is formed | | portion is formed |
| | | in block pattern) | | in rib pattern) |
| Side sliding | 1 | 1 | 0.1 | 0.1 |
| Wear resistance | 1.5 | 1.5 | 1 | 1 |

In the example 1, in a region with a large void ratio, an edge ply is disposed in an overlapping manner with an outer side of a cap ply in a tire radial direction, while in a region with a small void ratio, an edge ply is disposed adjacently to an inner side of the cap ply in the tire radial direction. For example, the above-mentioned first embodiment and third embodiment correspond to the example 1. On the other hand, in the comparison example 1, contrary to the example 1, in a region with a small void ratio, an edge ply is disposed in an overlapping manner with an outer side of a cap ply in the tire radial direction, while in a region with a large void ratio, an edge ply is disposed adjacently to an inner side of the cap ply in the tire radial direction.

In the example 2, in a region where a mediate portion is formed in a block pattern, an edge ply is disposed in an overlapping manner with an outer side of a cap ply in a tire radial direction, while in a region where a mediate portion is formed in a rib pattern, an edge ply is disposed adjacently to an inner side of the cap ply in the tire radial direction. For example, the above-mentioned second embodiment and fourth embodiment correspond to the example 2. On the other hand, in a comparison example 2, contrary to the example 2, in a region where a mediate portion is formed in a rib pattern, an edge ply is disposed in an overlapping manner with an outer side of a cap ply in a tire radial direction, while in a region where a mediate portion is formed in a block pattern, an edge ply is disposed adjacently to an inner side of the cap ply in the tire radial direction.

In the evaluation of side sliding, a lateral sliding distance (m) from a center line of a test course was measured when a steering angle is 0° in an actual vehicle steering stability test. The Table 1 shows that the closer to 0 the numerical value in Table 1 is, the lower the level of the side sliding is.

In the evaluation of the wear resistance, tires were worn by actual vehicle traveling of 12000 km and, thereafter, a wear amount of a center portion and a wear amount of a shoulder portion from a brand new state were measured. Numerical values in Table 1 indicate a rate of a wear amount of the shoulder portion to a wear amount of the center portion. Table 1 shows that the closer to 1 the numerical value is, the smaller an uneven wear amount in a width direction is and the more favorable the wear resistance of the tire is.

To compare the comparison example 1 and the example 1, the example 1 is superior to the comparison example 1 in both of side sliding and wear resistance. Based on such a result, it is confirmed that side sliding of a vehicle can be suppressed and wear resistance can be also enhanced by disposing an edge ply in an overlapping manner with an outer side of a cap ply in a tire radial direction in a region where a void ratio is large and by disposing an edge ply adjacently to an inner side of the cap ply in the tire radial direction in a region where a void ratio is small.

To compare the comparison example 2 and the example 2, the example 2 is superior to the comparison example 2 in both the side sliding and the wear resistance. Based on such a result, it is confirmed that side sliding of a vehicle can be suppressed and wear resistance can be also enhanced by disposing an edge ply in an overlapping manner with an outer side of a cap ply in a tire radial direction in a region where a mediate portion is formed in a block pattern, and by disposing an edge ply adjacently to an inner side of the cap ply in the tire radial direction in a region where a mediate portion is formed in a rib pattern.

What is claimed is:

1. A pneumatic tire comprising:
a tread portion having an asymmetrical pattern;
a belt layer disposed between a carcass and the tread portion, and having two or more belts;
a cap ply disposed between the belt layer and the tread portion so as to wholly cover the belt layer in a tire width direction; and
two edge plies disposed between the belt layer and the tread portion so as to respectively cover edge portions of the belt layer in a tire width direction,
where a first region with a first void ratio and a second region with a second void ratio are formed by dividing the tread portion in two by a tire equator plane,
wherein the edge ply is disposed outside the cap ply in a tire radial direction in the first region, and
wherein the edge ply is disposed inside the cap ply in the tire radial direction in the second region.

2. The pneumatic tire according to claim 1, wherein a tread pattern in a first mediate portion included in the first region is a block pattern, and a tread pattern in a second mediate portion included in the second region is a rib pattern.

3. The pneumatic tire according to claim 1, wherein the belt positioned on an outermost side in the tire radial direction among the belts which form the belt layer has a rate of a width to a total tire width set to 0.80 or more.

4. The pneumatic tire according to claim 2, wherein the belt positioned on an outermost side in the tire radial direction among the belts which form the belt layer has a rate of a width to a total tire width set to 0.80 or more.

5. The pneumatic tire according to claim 1, wherein an inclination angle of a straight line which connects an edge portion of the edge ply inside in the tire width direction in the first region and an edge portion of the edge ply inside in the tire width direction in the second region with respect to the tire width direction is set to a value which falls within a range from 1° to 10° inclusive.

6. The pneumatic tire according to claim 5, wherein a thickness of the belt layer on the tire equator plane is set to a value which falls within a range from 14 mm to 16 mm inclusive, and a thickness of the belt layer at an edge portion in the tire width direction is 0.4 times or more and 0.8 times or less as large as the thickness of the belt layer on the tire equator plane.

7. The pneumatic tire according to claim 1, wherein a width of the edge ply in the second region is 0.9 times or more and 1.1 times or less as large as a width of the edge ply in the first region.

8. The pneumatic tire according to claim 2, wherein a width of the edge ply in the second region is 0.9 times or more and 1.1 times or less as large as a width of the edge ply in the first region.

9. The pneumatic tire according to claim 1, wherein a projection amount of the edge ply from a ground contact edge is 5% or more and 20% or less of a total tire width.

10. The pneumatic tire according to claim 7, wherein a projection amount of the edge ply from a ground contact edge is 5% or more and 20% or less of a total tire width.

11. The pneumatic tire according to claim 8, wherein a projection amount of the edge ply from a ground contact edge is 5% or more and 20% or less of a total tire width.

12. A pneumatic tire comprising:
a tread portion having an asymmetrical pattern;
a belt layer disposed between a carcass and the tread portion, and having two or more belts;
a cap ply disposed between the belt layer and the tread portion so as to wholly cover the belt layer in a tire width direction; and
two edge plies disposed between the belt layer and the tread portion so as to respectively cover edge portions of the belt layer in a tire width direction
wherein a first region and a second region are formed by dividing the tread portion in two by a tire equator plane, a tread pattern in a first mediate portion included in the first region is a block pattern, and a tread pattern in a second mediate portion included in the second region is a rib pattern,
wherein the edge ply is disposed outside the cap ply in a tire radial direction in the first region, and
wherein the edge ply is disposed inside the cap ply in the tire radial direction in the second region.
